(19) United States
(12) Patent Application Publication
(10) Pub. No.: US 2002/0038256 A1
(43) Pub. Date: Mar. 28, 2002

(54) Transactional control system

(76) Inventor: Minh Nguyen, Wayland, MA (US)

Correspondence Address: LUCASH, GESMER & UPDEGROVE, LLP, 40 BROAD ST, SUITE 300, BOSTON, MA, 02109, US

(21) Appl. No.: 09/900,397

(22) Filed: Jul. 6, 2001

Related U.S. Application Data
(60) Provisional application No. 60/216,824, filed on Jul. 7, 2000.

(51) Int. Cl. G06F 17/60

(52) U.S. Cl. 705/26; 709/217

(57) ABSTRACT

The present invention provides systems and methods for enabling e-commerce merchants to create websites, and for customers of such merchants to access such websites. When an e-commerce function is accessed, a webpage having an HTML tag acting as a placeholder for the invoked function is sent to the transactional control system server. The control system is a server-side application that addresses the e-commerce component of a website. A servlet engine at the server invokes a servlet corresponding to the function specified by the HTML tag. A website can be created and implemented quickly and easily using the E-Commerce Transactional Control System of the present invention.

### REFERENCE TO RELATED APPLICATIONS

This application for U.S. patent claims the priority of related U.S. provisional application for patent Serial No. 60/216,824 (Attorney Docket: OneSource/Transactional), filed Jul. 7, 2000, the disclosure of which is incorporated herein by reference in its entirety.

### FIELD OF THE INVENTION

The present invention relates to creating and maintaining e-commerce websites, and more particularly relates to a website that allows users to create, update and access an electronic commerce website over the Internet.

### BACKGROUND OF THE INVENTION

The amount of retail business that is conducted over the Internet is increasing daily. More and more businesses must create e-commerce websites and provide access to customers who wish to purchase goods over the Internet in order to remain competitive in their field.

The Internet provides merchants the ability to sell their products to customers using an online e-commerce system. Online merchant systems allow such businesses to display and describe their products to shoppers using HTML Web pages accessed by potential customers using a browser, such as Microsoft Explorer or Netscape Navigator, installed on a client connected to the Internet. The customer can then electronically purchase products from the business. The e-commerce system then must add up the prices of the selected items, apply any discounts, add sales tax, process a credit card payment and then arrange for shipping of the selected items to the customer. Variations in all of these functions may occur from business to business. Any electronic commerce website system must be able to provide for substantial variations in the merchant's purchase transaction model. The business must also store product data, including descriptions, prices and pictures, in a database, along with inventory.

Web based stores are the businesses of the next generation. The Internet is attracting thousands of businesses each day that have a definitive need for Virtual hosting and an e-Commerce storefront. Once a decision has been made to open a Web based store, the search begins for software or “solutions” that are simple to set up and that quickly get their business online. Using prior art methods, a typical e-commerce website can take more than 300 hours to build, and then must be maintained and updated, also a time-consuming process.

E-commerce websites must have functionality allowing a merchant's customers to search for products, show special offerings, select products for purchase, and pay for purchases. The system also must coordinate these purchase orders with the inventory, manage inventory, provide customer administration and user administration. All of these functions must be integrated with each other.

It is therefore desirable to provide a system that allows a website designer to add e-commerce functionality to a merchant's website built from a storefront template or a customized storefront in less than a few hours.

It is further desirable to provide website designers with a variety of features and tools to make easier creating and maintaining an e-commerce web site.

It is also desirable to provide a system that allows website designers to design an e-commerce website with web-based administration to update a storefront, including deleting and modifying products and services, and updating images such as logos and product photos.

It is further desirable to provide a system allowing customers of a merchant's e-commerce storefront to use all the functionality of an electronic purchasing system.

It is also desirable to provide a system allowing a merchant's to administer an e-commerce storefront, including inventory, product administration, user administration, reports, and other such functions.

### SUMMARY OF THE INVENTION

The invention is an e-commerce transactional control system that is accessible from a browser on a user's computer. Among other features, the present invention allows a website designer to create, maintain, and update an e-commerce website over the Internet. A website designer integrates the e-commerce functionality into a merchant's website by naming each webpage according to a predefined name provided by the system. The name corresponds to one of the e-commerce functions provided by the system. Java servlet tags are then added to the page as a link to the function. This allows the website designer to add merchant e-commerce functionality, such as a shopping cart, credit card validation and payment, a purchase order system, Automatic E-mail order confirmation, product comparison, or other such e-commerce functions, directly onto the desired webpage.

When a user accesses the merchant's electronic storefront from a client computer, the server of the e-commerce system receives a web page having an HTML tag corresponding to a servlet e-commerce function. A servlet engine invokes the corresponding servlet, and the servlet communicates with a database to perform the function. The request is then processed, and the result is communicated back to the customer. The servlet functions correspond to the e-commerce functions, such as the shopping cart, product search, credit card processing, purchase order, checkout, and other such functions.

Although the system is described according to a preferred embodiment, other implementations are available according to the present invention, as will be seen by the following detailed description of the invention.

### BRIEF DESCRIPTION OF THE DRAWINGS

FIG. 1 is a diagram of the e-commerce website manager showing the components and dataflow of the system.

FIG. 2 shows the servlet engine of FIG. 1 in more detail.

FIG. 3 is a flowchart showing how a website designer creates a website using the OnlineBiz Quicksite Wizard provided by the assignee of the present invention.

FIG. 4 is a flowchart showing how a website designer creates a website using Dreamweaver before adding the E-commerce website functionality.

FIG. 5 is a flowchart showing the steps taken in implementing the E-commerce website functionality into a merchant's website as created according to FIG. 3 or FIG. 4.

FIG. 6 is a flowchart showing the steps taken when a customer accesses a merchant's the E-commerce website according to the invention.

### DETAILED DESCRIPTION OF THE INVENTION

The present invention will now be described in the context of a particular Internet e-commerce product that is provided by the applicant under the name OnlineBiz, accessible at www.myerete.com, a website that provides access to the system of present invention.

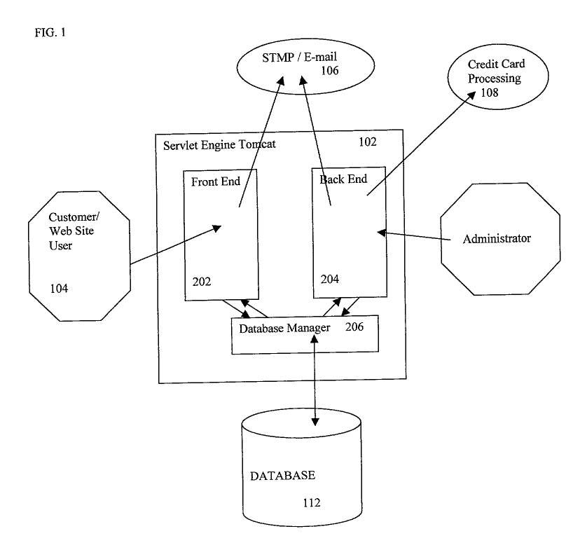

Referring to FIG. 1, the e-commerce website manager is shown. The e-commerce website manager of the present invention is comprised of a Servlet Engine 102, a front end administrator 202, a back end administrator 204 and a database manager 206. In the preferred embodiment, the servlet engine is a Tomcat-Jakarta. After the e-commerce website is created, and is in use, a customer, or web site user 104 accesses the front end over an Internet connection. The front end can send messages via an optional SMPT/Email interface 106. The merchant uses e-mail functions with the customer for e-mail confirmation of purchases, password requests, and return merchandise authorizations (RMAs). The back end 204 processes credit card transactions over credit card interface 108. The system administrator 110 maintains and controls the system through back end 204. The system stores and accesses records stored in the database 112 through database manager 206.

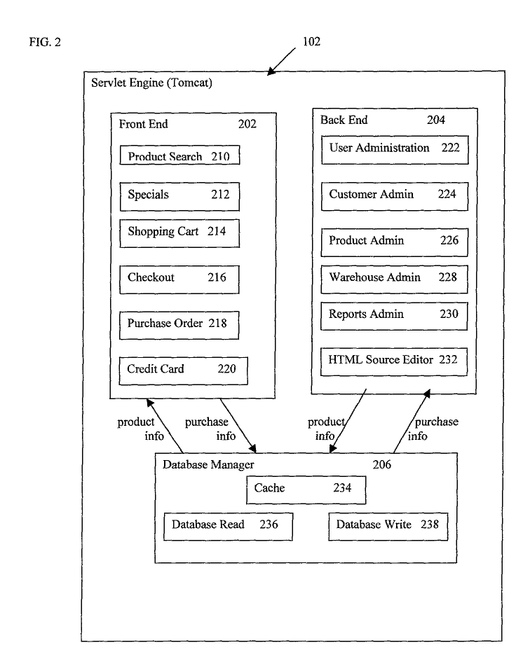

FIG. 2 shows the Servlet Engine 102 in more detail. The front end 202 contains several servlets, including product search 210, specials 212, shopping cart 214, checkout 216, purchase order 218 and credit card 220. The back end 204 also contains servlets, including user administration 222, customer administration 224, product administration 226, warehouse administration 228, reports administration 230 and HTML source editor 232. The database manager 206 contains a cache 234, database read 236 and database write 238.

After creating the website, a customer on the front end administrator 202 of the merchant's website can place an order. This process is powered by the Tomcat-Jakarta servlet engine 102. When the customer hits ‘pay by credit card’ accessing the “checkout” page link, that request will be sent to the checkout servlet 216. The servlet will then communicate with the database, retrieving all of the customers' current information. For credit payments, the servlet will then communicate with CSI and validate the card. To end the process and inform the customer that the transaction has gone through successfully, the servlet will first write the update to the database, then replace the servlet tags in the HTML page, displaying the customer their current information.

Implementation

The present invention is implemented using Java servlet technology with Tomcat-Jakarta as a built-in web server and servlet runner, JRE as a Java Virtual Machine, and MySQL as a built-in default database. A library of class files address all e-commerce functionality, which are invoked using remote method invocation (RMI).

Java is an object-oriented programming language and useful to transport objects between the client and server. It is also advantageous to invoke an object's method that resides on one computer by a program executing on another computer. Java generally uses the remote method invocation (RMI) interface to provide this capability. The RMI interface is described in Core Java, by Cornell and Horstmann, 2nd edition,© 1997 Sun Microsystems, Inc. Other interfaces (such as the CORBA standard) that provide similar functionality, and the present invention is not limited to the described implementation.

According to the present invention, the e-commerce website manager has a library of class files that address all of the e-commerce functionality that may be required by a merchant. These functions are invoked using RMI. HTML tags, which are placeholders for the chosen servlet functions, are inserted into the design pages. As a request is received from a client, the HTML tags are sent along with the HTML pages to the web server. The servlet engine 102 will then locate and identify the correct servlet that corresponds to the HTML tags being sent. The servlet will then communicate with the database 112, retrieving the correct parameters and posting the results back on the HTML page for the client to view. Each servlet has corresponding HTML tags that invoke specific e-commerce functionality.

As shown in FIG. 2, the web servlet engine 102 interacts with a set of servlets on the front end (210-220) and on the backend (222-232). In particular, the web servlet engine 102 interacts with these servlets through front end administrator 202 and back end administrator 204, respectively. Each servlet is a piece of software code used to dynamically generate information, and is an instantiated software object waiting to be invoked. Once it is invoked, it dynamically generates information. The servlets are operating in a continual loop waiting to be executed. When a customer accesses the e-commerce website and requests one of the e-commerce functions, such as the shopping cart, the web servlet engine 102 determines that dynamically generated information from a servlet object is required, and invokes the correct servlet, which in this case is Shopping Cart 214.

The servlets on the front end (210-220) and on the backend (222-232) are server extensions, a Java class that can be loaded dynamically to expand the functionality of a server. Servlets are commonly used with web servers, where they can take the place of CGI scripts. A servlet is similar to a proprietary server extension, except that it runs inside a Java Virtual Machine (JVM) on the server, so it is safe and portable. Servlets operate solely within the domain of the server: unlike applets, they do not require support for Java in the web browser. Unlike CGI and FastCGI, which must use multiple processes to handle separate programs and/or separate requests, servlets can all be handled by separate threads within the same process or by threads within multiple processes spread across a number of backend servers. This means that the servlets are also efficient and scalable. Because the servlets run with bidirectional communication to the web server, they can interact very closely with the server to do things that are not possible with CGI scripts. Another advantage of servlets is that they are portable: both across operating systems and also across web servers. All the major web servers and application servers support servlets.

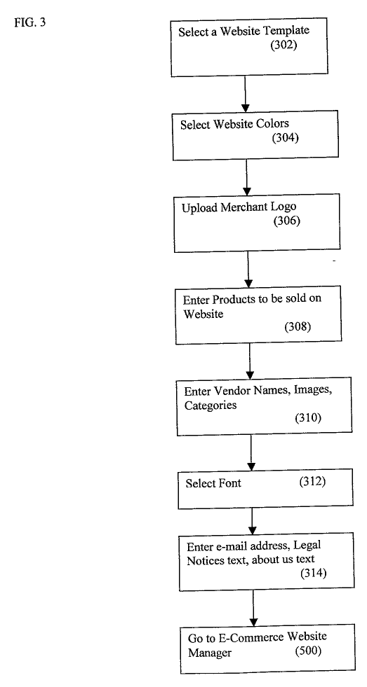

As shown in FIG. 3, a merchant with little or no computer knowledge can access the OnlineBiz Quicksite Wizard and build a website using the wizard provided through the myerete.com website. A merchant can design a website and can then add the e-commerce components provided by the present invention. OnlineBiz includes a web-based wizard to guide merchants through the setup and layout, including color, of their store. There is no need for knowledge of HTML or FTP in order to customize a Web site, or to update or modify the website.

The merchant first selects a website template from variety of available templates (302). The merchant then selects colors for each part of the website, including the header, border, text, visited link, active link, link and background (304). The merchant's logo image is then uploaded into the website (306). The products can then be organized on the website according to vendor name, image, and category. Each vendor's name and image is entered into the website (308). The merchant can then enter the categories of the various products that will be sold on the website (310). A multiple number of vendor's name and images, and categories can be entered. The merchant then selects the font (312), enters an e-mail address for a “contact-us” link, and enters text for a “legal notices” page and an “about us” page (314).

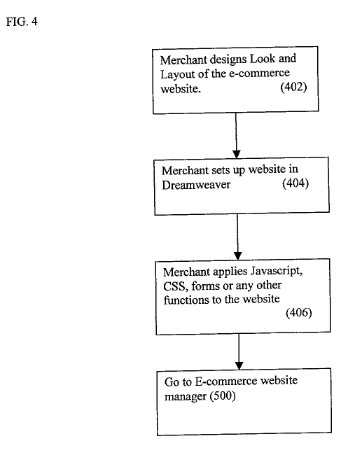

As shown in FIG. 4, to embed the e-commerce services on a website using “Dreamweaver”, the business designs the look and layout of the website (402). The merchant then sets up the website in Dreamweaver (404), and applies javascript, CSS, forms, or any other functions as the website would normally be built. (406). The website designer can then add the e-commerce functions (500) as provided by the present invention. Once the OnlineBiz Dreamweaver extension is installed, the website designer can access all e-Commerce functions through the Insert Menu. The website designer selects the desired function, and the function will drop onto page.

Creating an E-Commerce Website

To use the system, and create an e-commerce website, the merchant's website designer accesses a browser selects a link to the OnlineBiz system using the “www.myerete.com” Universal Resource Locator (URL). Although the system is accessed, according to the preferred embodiment, over the Internet, it can also be accessed over other networks. The website designer can then add e-commerce functionality to an existing website, or can design a website that includes e-commerce functionality using the tools provided. The system provides multi-database support for MySQL and Oracle database management systems.

The website designer can access the website and create a website with e-commerce functionality, including a full featured product search, a shopping cart capability, the ability to compare products and configurations, an automated Return Merchandise Authorization (RMA), an automated UPS shipping & tracking system, and tax calculation. The system provides a built-in Web server for the merchant.

The system of the present invention also provides administration functions for the business. It provides IP-based user tracking for each accessed page to assist in targeted promotion. The system also provides backend user control with database modification, administration and remote configuration functions available for the business. Inventory control, supporting real-time and non-exhaustible methods is also provided. The system allows the business to manage products and provide data reporting, along with custom database reporting.

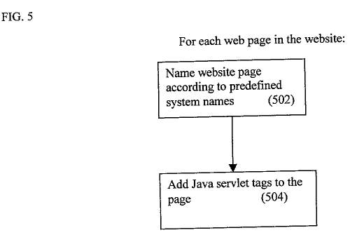

FIG. 5 shows the steps involved in implementing the E-commerce website manager according to the present invention. Each webpage is named according to the predefined name provided by the system (502). For example, the website's order page of a page named “store.com” would have the “order.html*” in the name of the page, as follows: “store.com(order.html*)”. The java servlet tags are then added to the page (504). For example “link/servlet/ws2_control” is added onto the merchant page as a link. This allows the website designer to add merchant e-commerce functionality, such as a shopping cart, a purchase order system or a product comparison function, directly onto the desired webpage. In this way, the website designer can add such functions as credit card validation and payment (via Credit Services International or other authorized financial vendors), Automatic Email order confirmation, and Purchase order validation and order completion to the website.

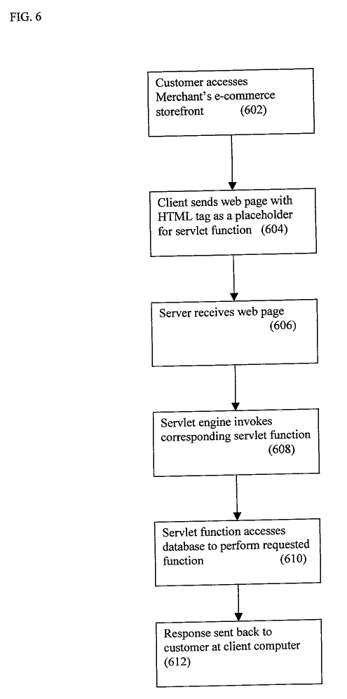

FIG. 6 shows how the transactional control system of the present invention operates when accessed by a customer at a client computer over the Internet. The client computer accesses the merchant's e-commerce website (602) as created according to FIGS. 3, 4 and 5. The client computer sends a web page with an HTML tag as a placeholder for a servlet function (604). The server receives the web page (606) and the servlet engine invokes the corresponding servlet function (608). The invoked servlet accesses the database to process the request (610), and the server sends the response back to the user (612).

The present invention operates as a “State Machine”, and can be defined as:

A set of input events

A set of output events

A set of states

A function that maps states and input to output

A function that maps states and inputs to states

A description of the initial state

The input events for the present invention are the HTTP GET and HTTP POST requests given by users and customers as they use the front and backend pages. The output events are responses to the users and customers (in the form of web pages) and writes to hard disks and terminal windows (error logs). The states that the present invention can represent are more than just the status of orders, as the status of users, customers, orders, sales, shopping carts, usage statistics, and inventory are all part of the state of the web store.

The initial state of the present invention is the (largely empty) store that was first created when the merchant installed the e-commerce system. The mapping of states and input(s) to output and to other states is the job of the java servlets. These servlets break apart a HTTP request (GET or POST), determine what information the user is looking for (searching for products, etc.), or what the user wants to update (changing the status of an order, updating user information, etc.), ascertain whether or not they should be allowed to see that information (user name and password check), send either a rejection message, successful update message, or the requested information to the user, and if needed, write any changes to the server's disk. The template pages represent the initial, empty state of parts of the web store. When the servlets read these pages, they fill them in with the current state of the store, and send them to the user. If the user has an update to make, he or she will click on a link on one of the pages modified by the servlet, possibly with additional information added or modified (perhaps the administrator changed a user's first name). The servlet takes this information, changes the state of the store if needed, and reports any output.

The system uses a Unified Modeling Language (“UML”) object model, and the code for the various functions is included herein in the attached Appendix A, including the following:

ws2_cache: controls the cache flow

ws2_calculate_order: calculates the order

ws2_cccard: controls credit card function

ws2_control_connection: generates the final order message

ws2_control_index:

ws2_control_order: controls the checkout process

ws2_control_po: controls customer Purchase Orders

ws2_control_shop: displays search results

ws2_control_test: generic text cradle

ws2_control_user: controls customer account page (front end)

ws2_crdsrvint: card service international authorization

ws2_globaltrack: validates login/controls session variables

ws2_htmlparse: string functions/email data functions

ws2_io_r: reads from database

ws2_io_w: writes from database

ws2_ups: controls UPS connection

Also included are UML Standard Module Templates for:

ws2_ups, ws2_ccard, ws2_control_shop; ws2_io_w; ws2_control_cart, ws2_control_user; ws2_control_order; ws2_calculate_order; ws2_control_connection; ws2_control_test; and ws2_control_PO.

The reader will understand that the concepts underlying the present invention may be applied to any number of systems and may be implemented using other technologies.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. An electronic commerce website manager on a server computer comprising:
a plurality of servlets, wherein each servlet implements an e-commerce function;
a servlet engine for invoking one of the plurality of servlets;
a database in communication with the servlet function;
means for receiving a web page from a client wherein the web page is comprised of at least one HTML tag and the HTML tag is a placeholder for one of the servlet functions; and
means for invoking the servlet corresponding to the servlet function referenced by the HTML tag.

2. The electronic commerce website manager of claim 1 further comprising a front end administrator for communication with a user.

3. The electronic commerce website manager of claim 2 further comprising a back end administrator for communication with a system administrator.

4. The electronic commerce website manager of claim 3 wherein the back end administrator provides business administration functions.

5. The electronic commerce website manager of claim 4 wherein the administration functions are comprised of one of: IP-based user tracking for accessed pages, backend user control, database modification, remote configuration, inventory control, or database reporting.

6. The electronic commerce website manager of claim 1 further comprising providing predefined names for embedding in a name of a page of a user's website.

7. The electronic commerce website manager of claim 1 further comprising means for interpreting a servlet tag on a user's webpage.

8. The electronic commerce website manager of claim 7 wherein the servlet tag on the user's webpage corresponds to a provided e-commerce function.

9. The electronic commerce website manager of claim 8 wherein an e-commerce function corresponds to one of a shopping cart, a purchase order request, a product comparison function, credit card validation, payment, automatic email order confirmation, purchase order validation, order completion, Return Merchandise Authorization (RMA), or an automated shipping & tracking system.

10. A method for managing an E-commerce website comprising:
receiving a user's webpage named according to a predefined name and having a tag linking the user's webpage to an e-commerce function;
invoking the e-commerce function corresponding to the received tag;
accessing a database to process the e-commerce function;
sending a response to the user;
wherein an e-commerce function is comprised of one of: a shopping cart, a purchase order system, a product comparison function, credit card validation and payment, automatic e-mail order confirmation, purchase order validation or order completion.
